(19) United States
(12) Patent Application Publication
(10) Pub. No.: US 2007/0067563 A1
(43) Pub. Date: Mar. 22, 2007

(54) Updating disk drive firmware behind RAID controllers

(75) Inventors: Gerald Smith, Suwanee, GA (US); Parag Maharana, Fremont, CA (US); Atul Mukker, Norcross, GA (US)

Correspondence Address: LSI LOGIC CORPORATION, 1621 BARBER LANE, MS: D-106, MILPITAS, CA, 95035, US

(73) Assignee: LSI Logic Corporation

(21) Appl. No.: 11/230,368

(22) Filed: Sep. 19, 2005

(51) Int. Cl. G06F 12/16

(52) U.S. Cl. 711/114

(57) ABSTRACT

A system, apparatus and method for updating disk drive firmware is described. In one embodiment of the invention, the disk drive firmware is contained within a RAID environment. A flash mode is provided in which physical drives within the RAID are exposed to an operating system. The flash mode may limit the access and commands of the operating system to the drives in order to prevent errors such as read/write errors. During flash mode, the OS may flash a drive firmware in order to provide an update. Once the update is complete, flash mode is deactivated and the RAID returns to normal operation.

### BACKGROUND

A. Technical Field

This invention relates to updating firmware of disk drives and more particularly to method and system for updating firmware of disk drives behind Redundant Array of Independent Disks (“RAID”) controllers.

B. Background of the Invention

RAID storage systems include multiple disk drives for storing and replicating data across the drives for increasing data integrity, fault-tolerance and overall performances, and also include a controller(s) to manage the storage of data on the disks. The use of multiple drives within the RAID allows the recordation of redundant information on the disk drives so that lost data may be reconstructed in the event of a drive failure or data corruption. These physical disk drives within a RAID are typically hidden from an operating system and the RAID is presented as a virtual drive to the operating system.

Typically in a RAID storage device, the disk drives are set behind the RAID controller. As mentioned above, these disk drives are hidden from the system and an operating system is allowed to access only virtual or logical drives and not the physical disk drives. Oftentimes, firmware associated with a single disk drive or multiple drives within a RAID require a data update at the time of installation or subsequent to installation. This update process may be difficult because of the location of the drives behind the RAID controller and corresponding accessibility of the physical drive(s) by an operating system.

Certain RAID controllers have a way to bypass the perceived virtual drive and allow communication directly to the physical drive; however, this bypass process varies for different RAID controllers and presents risk to data stored within the RAID. If a RAID controller exposes physical disk drives, as well as logical drives together, then there is a risk of data corruption when a user creates a partition in an exposed disk drive or if certain data is written to or read from the exposed drive. Additionally, if this exposed disk drive is part of a logical drive, then the controller may lose RAID configuration information or cause a conflict with the usage of the logical drive.

These dangers in exposing drives within a RAID so that firmware may be flashed are poorly addressed in current disk drive flashing methods. One such method is connecting these disk drives behind a SAS controller (non-RAID controller). In this method, disk drives are removed from the RAID storage device and connected to a SAS controller resulting in the exposure of a physical disk drive(s) to the operating system. Because the drive is physically removed from the RAID, the drive will not receive any commands from the operating system. Once the drives are exposed to the operating system, respective disk drive utilities can flash their own firmware. After the firmware has been successfully updated, the disk drive is put back into the original RAID system.

Another method of updating disk drive firmware is having a supplier provide its own utilities to communicate with a specific RAID controller to expose a particular drive. Because there are a large number of different types of RAID controllers from various vendors, providing specific flash utilities that address each RAID controller would be a daunting task and require additional storage space.

Accordingly, what is desired is a system, apparatus and method that address the above-described concerns.

### SUMMARY OF THE INVENTION

The present invention provides a method and apparatus to flash disk drive firmware in a RAID system in order to update data stored within the firmware. In one embodiment, physical drives are exposed and certain read/write limitations are provided in such a way to allow firmware to be updated without risking corruption of data stored in the RAID.

In one embodiment of the present invention, a flash mode is provided that may be activated and deactivated by an operating system or disk drive utility. During the flash mode, a physical disk drive(s) within the RAID is exposed and updated with data. In addition, read and write commands to the exposed drive(s) are limited to avoid conflicts, data corruption, etc. that may be caused by commands from the operating system during the flash mode. For example, the RAID controller may respond to a write command with a failure and a read command with a particular bit string, such as a zeroed out response. After the firmware is updated, the physical disk drives are no longer exposed and the RAID controller may properly respond to commands that occurred during flash mode.

In another embodiment of the present invention, a set of commands may be provided by the operating system to the RAID controller to effectively activate and deactivate flash mode. Accordingly, an operating system may recognize that a disk drive utility that updates firmware is present and initiate flash mode so that the update may occur. Thereafter, the physical disk drive within the RAID may once again be hidden from the operating system.

In yet another embodiment, a set of commands may be provided to the RAID controller, which displays the physical drives within a RAID to a user. The user may then manually select a physical drive or drives, expose the selected drive(s) to the operating system and perform an operation accordingly. One skilled in the art will recognize that various operations such a firmware updates, drive configurations and other operations may be performed on the exposed drive(s).

Other objects, features and advantages of the invention will be apparent from the drawings, and from the detailed description that follows below.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 shows a block diagram of a system for updating disk drive firmware according to one embodiment of the invention.

FIG. 2 is a block diagram of a RAID controller according to one embodiment of the invention.

FIG. 3 is a flowchart for updating disk drive firmware within a RAID according to one embodiment of the invention.

### DETAILED DESCRIPTION OF THE PREFERRED EMBODIMENTS

A system, apparatus and method for updating disk drive firmware is described. In one embodiment of the invention, the disk drive firmware is contained within a RAID environment. A flash mode is provided in which physical drives within the RAID are exposed to an operating system. The flash mode may limit the access and commands of the operating system to the drives in order to prevent errors such as read/write errors. During flash mode, the OS may flash a drive firmware in order to provide an update. Once the update is complete, flash mode is deactivated and the RAID returns to normal operation.

Various other embodiments of the invention are described below including a command in which certain drives within a RAID that may not be flashed by the OS or are not responsive to update commands are identified and shown to a user.

In the following description, for purpose of explanation, specific details are set forth in order to provide an understanding of the invention. It will be apparent, however, to one skilled in the art that the invention may be practiced without these details. One skilled in the art will recognize that embodiments of the present invention, some of which are described below, may be incorporated into a number of different systems and devices including storage environments such as RAID storage systems. The embodiments of the present invention may also be present in software, hardware or firmware. Structures and devices shown below in block diagram are illustrative of exemplary embodiments of the invention and are meant to avoid obscuring the invention. Furthermore, connections between components and/or modules within the figures are not intended to be limited to direct connections. Rather, data between these components and modules may be modified, re-formatted or otherwise changed by intermediary components and modules.

Reference in the specification to “one embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

A. System Overview

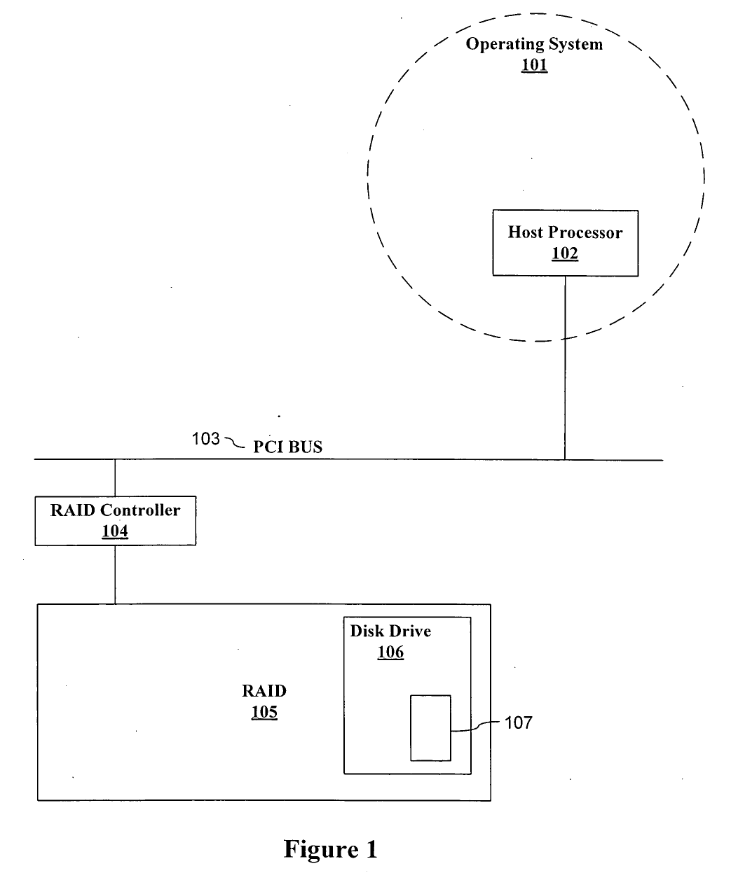

FIG. 1 illustrates a RAID and operating system according to one embodiment of the invention. A RAID storage device 105 is shown which is generally a collection of multiple storage disks drives arranged in an array with one or more controllers to manage the storage of data on the disks. The storage technique involved in a RAID is a performance enhancing method for storing data across multiple hard disks within an array in order to improve performance and provide data redundancy. This redundancy allows a RAID to reconstruct lost or corrupted data should such an event occur.

In one embodiment of the invention, the RAID storage device 105 is connected to a RAID controller 104 which is configured for organizing storage and retrieval of data on disk drive(s) 106. The RAID controller 104 may be connected to a host processor 102 via a PCI bus 103. The host processor 102 is generally supported by an operating system 101 with which the RAID 105 communicates. The RAID controller 104 communicates with the disk drives 106 to control access of the disk drive(s) 106 and I/O requests made by the host processor 102. The I/O requests are generally used to perform certain read and write operations on the data stored within disk drive(s) 106.

Each disk drive 106 in a RAID 105 contains disk drive firmware 107 which is used to control storage functionality of the disk drive 106. This firmware 107 in general refers to software that may be burned into any kind of memory chip such as a Read-Only Memory (ROM) or a hard drive. The firmware 107 may be configured to perform other functions such as sector re-mapping, monitoring the disk for failures, etc.

The communication between an operating system and a peripheral, such as a RAID array, occurs on the PCI bus 103 and contains various standard commands to allow communication with peripherals from different vendors. This communication may occur on other types of communication medium including PCI-X or PCI Express buses. In response to a command or command set, the RAID controller 104 initiates a flash mode and the physical disk drives 106 within the RAID 105 are exposed to the operating system 101 so that the operating system 101 may perform an update on drive firmware. In one embodiment, the host processor 102 may flash the physical drive(s) 106 in order to provide an update to the drive(s) firmware 107. During this flash mode, the RAID controller 104 limits the commands and ability of the operating system 101 to access this exposed physical drive(s) 106.

The RAID controller 104 prevents the operating system 101 from performing read and write operations on the exposed physical drive(s) 106 during flash mode. This limitation protects data within the RAID and avoids read/write conflicts on the exposed physical drive(s) 106. In one embodiment of the present invention, the RAID controller 104 provides a particular data string in response to a read command. For example, a read operation may be zeroed out meaning that the read operation successfully completed with a string of zeroes. In yet another example, a write operation performed during flash mode may complete with failure. Other types of operations that may harm data within the drive may be blocked by the RAID controller 104 (such as a formatting command).

In traditional RAID systems, input/out operations are performed by an operating system that believes a RAID is a physical drive while in actuality the commands are sent to the virtual drive. In other words, different physical drives within the RAID are accessed by the RAID controller 104 which translates these I/O commands from the operating system 101 relative to the RAID virtual drive. Accordingly, other embodiments of the present invention may leverage the exposure of physical drives within the RAID using standard command sets. In some cases, these standard commands can be used when a user wants to monitor some information on the drive. Further, these commands may also be used by the operating system 101 or other utilities to accomplish certain input/output activities on the drives. In one embodiment, a command may be available in which certain physical drives within the RAID 106 are displayed to a user according to a particular parameter. For example, if the operating system attempts to flash each drive within the RAID 106 and certain drives do not respond to a flash command or parameter, these unresponsive physical drives may be provided to a user or the operating system 101.

B. RAID Controller

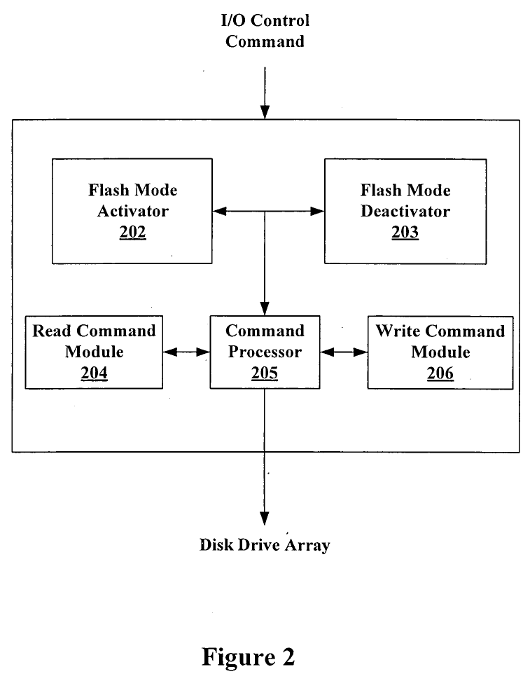

FIG. 2 illustrates a RAID controller 104 according to one embodiment of the invention. The RAID controller 104 receives I/O control commands from other devices such as the host processor 102 within the operating system 101. In one embodiment, the RAID controller has a command processor 205 that receives these commands and interfaces with a flash mode activator 202, a flash mode deactivator 203, a read command module 204, and a write command module 206, which may be maintained within a memory device on the RAID controller 104.

In one embodiment of the invention, the RAID controller 104 may operate in flash mode, which may be triggered by an I/O control command or parameter. For example, the flash mode may be triggered at a load time of a disk drive into the RAID. The flash mode activator 202 contains data related to triggering a flash mode so that the command processor 205 may recognize such a command or parameter. The flash mode deactivator 203 contains data related to ending a flash mode so that the command processor 205 may recognize when to end a flash mode and return to normal operation.

As described above, when the RAID controller 104 operates in flash mode, it provides limited access capability to exposed physical disk drives. In one embodiment, the write command module 206 may define a particular response to a write command, such as returning a failure in response to the write command. The read command module 204 may also define a particular response to a read command, such as a returning a successful operation as zeroed out data string. One skilled in the art will recognize that various responses to commands may be provided and defined in accordance with the present invention. Furthermore, one skilled in the art will recognize that various commands and accessing parameters may be blocked, refined, or otherwise modified in order to protect stored data during the flash mode operation.

C. Method of Flashing Disk Drive Firmware

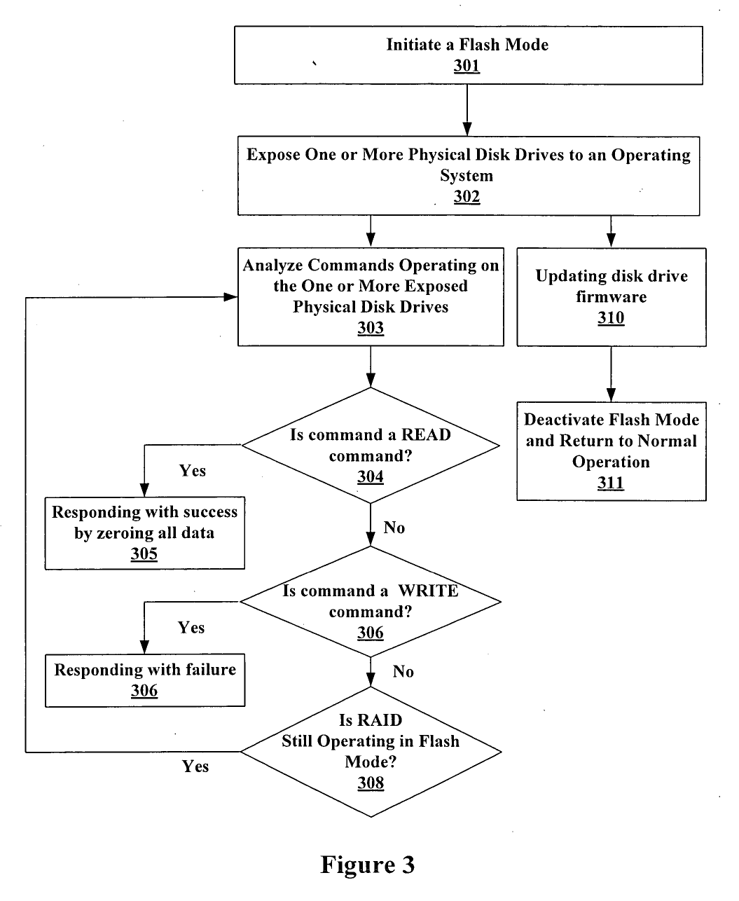

FIG. 3 illustrates a method, independent of structure, for flashing disk drive firmware according to one embodiment of the invention. A flash mode is initiated 301 by a command or parameter within a RAID system. In response to the flash mode being initiated, one or more physical disk drives within the RAID are exposed 302 to an operating system. Firmware associated with one or more of the exposed physical disk drives is updated 310. Once the firmware is updated, the flash mode is deactivated and the system returns to normal operation 311.

During flash mode, commands operating on the exposed physical disk drive(s) are processed 303 in a manner to ensure data integrity within the drive. For example, if a command is a read command 304, then a RAID controller provides 305 a successful response of a zeroed out data. If a command is a write command 306, then the RAID controller responds 307 with a failure. This command analysis is performed until flash mode is deactivated 308. Accordingly, data on the exposed disk drive(s) is protected while the system operates in flash mode.

While the present invention has been described with reference to certain exemplary embodiments, those skilled in the art will recognize that various modifications may be provided. Accordingly, the scope of the invention is to be limited only by the following claims.

We claim:

1. A method of updating firmware located behind a RAID controller, the method comprising:
exposing at least one physical disk drive within a RAID to an operating system;
limiting the commands from the operating system that operate on the at least one exposed physical disk drive; and
updating the firmware associated with the at least one exposed physical drive.

2. The method of claim 1, wherein the at least one physical disk drive is exposed in response to a command from the operating system.

3. The method of claim 1, wherein the at least one physical disk drive is exposed in response to a parameter.

4. The method of claim 1, wherein the RAID controller responds to a read command on the at least one exposed physical disk drive with a success response have a particular data string.

5. The method of claim 4 wherein the particular data string is a set of zeroed data.

6. The method of claim 1 further comprising the step of hiding the at least one exposed physical disk drive after the firmware has been updated.

7. A RAID controller that receives commands from a bus, the controller comprising:
a bus interface that receives data from the bus;
a command processor, coupled to the bus interface, that receives commands;
a flash mode activator, coupled to the command processor, that exposes at least one physical disk drive within a RAID to an operating system; and
a flash mode deactivator, coupled to the command processor, that hides the at least one physical disk drive with the RAID from the operating system.

8. The controller of claim 7 wherein the flash mode activator exposes the at least one physical disk drive in response to a command received from the bus.

9. The controller of claim 7 wherein the flash mode deactivator hides the at least one physical disk drive in response to a command received from the bus.

10. The controller of claim 7 further comprising:
a read command module, coupled to the command processor, that responds to a read command, operable on the at least one exposed physical disk drive, with a pre-defined response; and
a write command module, coupled to the command processor, that responds to a write command, operable on the at least one exposed physical disk drive, with a predefined response.

11. The controller of claim 10 wherein the read command module responds to the read command with a set of zeroed out data.

12. The controller of claim 10 wherein the write command module responds to the write command with a failure.

13. The controller of claim 7 wherein the flash mode activator exposes the at least one physical disk drive in response to a parameter realized within the RAID.

14. A computer program product embodied on a computer readable medium for enabling the update of disk drive firmware located behind a RAID controller, the computer program product comprising computer instructions for:
exposing at least one physical disk drive within a RAID to an operating system;
limiting the commands from the operating system that operate on the at least one exposed physical disk drive; and
updating the disk drive firmware associated with the at least one exposed physical drive.

15. The computer program product of claim 14 wherein the at least one physical disk drive is exposed in response to a command from the operating system.

16. The computer program product of claim 14, wherein the at least one physical disk drive is exposed in response to a parameter.

17. The computer program product of claim 14, wherein the RAID controller responds to a read command on the at least one exposed physical disk drive with a success response have a particular data string.

18. The computer program product of claim 17 wherein the particular data string is a set of zeroed data.

19. The computer program product of claim 1 further comprising instructions for hiding the at least one exposed physical disk drive after the firmware has been updated.
